(19) United States
(12) Patent Application Publication
(10) Pub. No.: US 2012/0236381 A1
(43) Pub. Date: Sep. 20, 2012

(54) Image Forming Apparatus

(75) Inventor: Masahiko Oikawa, Kanagawa (JP)

(73) Assignee: Ricoh Company, Ltd., Tokyo (JP)

(21) Appl. No.: 13/398,906

(22) Filed: Feb. 17, 2012

(30) Foreign Application Priority Data
Mar. 17, 2011 (JP) 2011-059606

(51) Int. Cl. G02B 26/10

(52) U.S. Cl. 359/205.1

(57) ABSTRACT

An image forming apparatus, including a deflector including a rotational axis and at least two-staged polygon mirrors circumferentially located on the rotational axis at shifted angles in a rotational direction thereof, to reflect a light beam entering each of the polygon mirrors while deflecting the light beam to scan plural image bearers; a divider to divide the light beam from a light source into at least two light beams to enter the polygon mirrors at different stages, respectively; a light receiver to detect the light beam reflected from the deflector; a detector to detect timings of the two-staged polygon mirrors to scan, based on a light beam detection interval detected by the light receiver; and alight shutter to shut a light beam entering an unused image bearer among the plural image bearers during a period when the light source lights up before the detector detects the timings.

### CROSS-REFERENCE TO RELATED APPLICATIONS

This patent application is based on and claims priority pursuant to 35 U.S.C. §119 to Japanese Patent Application No. 2011-059606, filed on Mar. 17, 2011, in the Japanese Patent Office, the entire disclosure of which is hereby incorporated herein by reference.

### FIELD OF THE INVENTION

The present invention relates to an image forming apparatus including a facsimile, a printer, a copier and a multifunctional machine.

### BACKGROUND OF THE INVENTION

Tandem electrophotographic image forming apparatuses including plural photoreceptors such as photoreceptor drums are being mostly used in laser printers, facsimiles and digital multifunctional machines because of being required to produce full-color images or images at higher speed.

In the tandem image forming apparatuses, since a light beam such as laser beams from a laser diode light source needs irradiating each of the plural photoreceptors, the more the photoreceptors, the more the light sources emitting light beams.

Increase of the light sources causes increase of components, increase of cost of the image forming apparatus, and further color shifts due to differences of wavelengths among the plural light sources.

Further, the increase of the light sources causes increase of failure probability of a writing unit due to deterioration of the light sources, and deterioration of recyclability.

In order not to increase light sources, Japanese published unexamined application No. 2006-284822 discloses an image forming apparatus in which a light beam emitted from a common light source is divided into plural light beams scanning different surfaces to be scanned.

The image forming apparatus divides emitted light flux from a light source into two with a light flux divider. The two fluxes enter two polygon mirrors, respectively, which are attached to a deflector at a shifted angle one above the other, which coaxially rotates the mirrors. Each of the light fluxes deflectively scanned by the deflector at a different timing reaches an individual photoreceptor to mainly scan the photoreceptor through optical predetermined systems, i.e., a first scanning lens, a mirror and a second scanning lens.

Thus, plural polygon mirrors scan different surface to be scanned to decrease light sources. However, quality images can be produced at high speed without ghost light. Decrease of not sources decreases components in an image forming apparatus to save cost and failure probability of the apparatus, and improves recyclability thereof.

Japanese published unexamined application No. 2010-072634 discloses an image forming apparatus in which a shift angle of each polygon mirror is set such that each light flux deflectively scanned by a light receiver does not have a regular detection interval, which polygon mirror scans at which timing is detectable, and a suitable color image can be scanned on a surface to be scanned.

In a typical full-color image forming apparatus, an electrostatic latent image is formed on each of photoreceptor drums, and an individual toner image of each color is formed with four color toners, i.e., black (K), cyan (C), yellow (Y), and magenta (M).

The 4 photoreceptor drums and the 4 scanned surfaces are correspondent to each other.

For example, in an image forming apparatus in which black and cyan are scanned at an upper stage and a lower stage, respectively, black and a polygon mirror at the upper stage, cyan and polygon mirror at the lower stage are correspondent to each other, respectively.

Similarly, in an image forming apparatus in which yellow and magenta are scanned at an upper stage and a lower stage, respectively, a polygon mirror of each stage forms an electrostatic latent image and a final full-color image is properly produced.

However, in the above-mentioned image forming apparatus, light beams divided from the same light source always enter the polygon mirrors at the upper and lower stages, and the light beam even irradiates the photoreceptor for a color unused when a monochrome image is formed.

Namely, a photoreceptor which is not use sops without rotating and a light beam irradiates the same position thereof, and further the light beam having almost a full power irradiates the position for a long time because of being uncontrollable during a nonsynchronous lighting period before a synchronous detection is performed.

When the light beam having almost a full power irradiates the same position for a long time, the position has such a potential level as no to be eliminated even by a discharge process.

Therefore, although only the black photoreceptor is required to be irradiated, even the cyan photoreceptor is irradiated as well and undesired electrostatic latent images such as stripes are formed thereon, resulting in production of abnormal images.

Because of these reasons, a need exists for an image forming apparatus in which a light beam running into a polygon mirror for a photoreceptor unused is shut out when printing monochrome images.

### SUMMARY OF THE INVENTION

Accordingly, an object of the present invention is to provide an image forming apparatus in which a light beam running into a polygon mirror for a photoreceptor unused is shut out when printing monochrome images.

The object of the present invention, either individually or collectively, have been satisfied by the discovery of an image forming apparatus, comprising:

a deflector, comprising a rotational axis and at least two-staged polygon mirrors circumferentially located on the rotational axis at shifted angles in a rotational direction thereof, configured to reflect a light beam entering each of the polygon mirrors while deflecting the light beam to scan plural image bearers;

a divider configured to divide the light beam from alight source into at least two light beams to enter the polygon mirrors at different stages, respectively;

a light receiver configured to detect the light beam reflected from the deflector;

a detector configured to detect timings of the two-staged polygon mirrors to scan, based on a light beam detection interval detected by the light receiver; and

a light shutter configured to shut a light beam entering unused image bearers among the plural image bearers during a period when the light source lights up before the detector detects the timings.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

FIG. 1 is a schematic view illustrating an embodiment of the image forming apparatus of the present invention;

FIG. 2 is a schematic view illustrating an inner configuration of an optical scanner in FIG. 1;

FIG. 3 is an apparent perspective view illustrating a half mirror prism in FIG. 2;

FIGS. 4A, 4B and 4C are apparent views illustrating an upper face, a side face and a bottom face of the polygon mirror in FIG. 2;

FIGS. 5A and 5B are schematic views for explaining movement of the polygon mirror in FIG. 2;

FIG. 6 is a diagram showing a main configuration of a controller of the optical scanner in FIG. 1;

FIG. 7 is a diagram showing a signal variation relating to a conventional operation of the optical scanner when producing monochrome images while opening the light shutter in FIG. 6;

FIGS. 8A and 8B are schematic views illustrating a mechanical shutter used as the light shutter in FIG. 6;

FIGS. 9A and 9B are schematic views illustrating emitting direction of the light beam at ON/OFF of electric field application when a liquid crystal shutter is used as the light shutter in FIG. 6; and

FIG. 10 is a diagram showing a signal variation relating to an operation of the optical scanner when monochrome images are produced using the light shutter in FIG. 6.

### DETAILED DESCRIPTION OF THE INVENTION

The present invention provides an image forming apparatus in which a light beam running into a polygon mirror for a photoreceptor unused is shut out when printing monochrome images.

More particularly, the present invention relates to an image forming apparatus, comprising:

a deflector, comprising a rotational axis and at least two-staged polygon mirrors circumferentially located on the rotational axis at shifted angles in a rotational direction thereof, configured to reflect a light beam entering each of the polygon mirrors while deflecting the light beam to scan plural image bearers;

a divider configured to divide the light beam from a light source into a east two light beams to enter the polygon mirrors at different stages, respectively;

a light receiver configured to detect the light beam reflected from the deflector;

a detector configured to detect timings of the two-staged polygon mirrors to scan, based on a light beam detection interval detected by the light receiver; and

a light shutter configured to shut a light beam entering unused image bearers among the plural image bearers during a period when the light source lights up before the detector detects the timings.

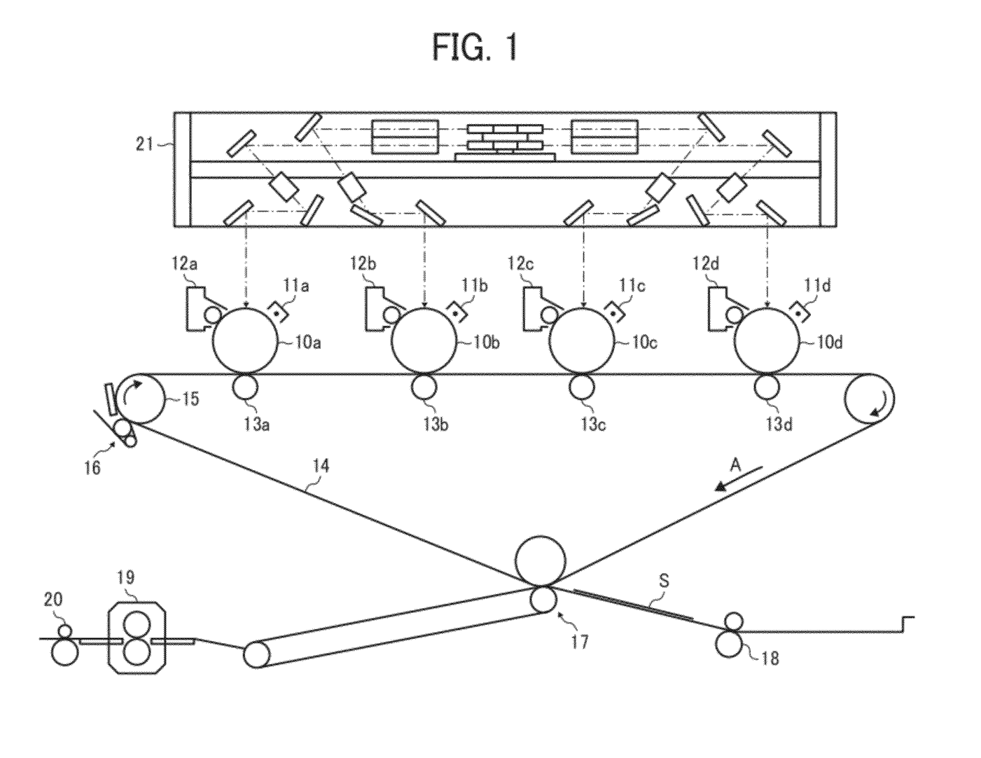

FIG. 1 is a schematic view illustrating an embodiment of the image forming apparatus of the present invention.

The image forming apparatus is an image forming apparatus equipped with a tandem full-color image forming means, including a facsimile, a printer, a copier and a multifunctional machine.

The image forming apparatus includes 4 photoreceptor drums 10a to 10d, charging units 11a to 11d, and 4 toner cartridges 12a to 12d, transfer rollers 13a to 13c1, unillustrated cleaners removing toners on the photoreceptor drums 10a to 10d, nn intermediate transfer belt 14, an intermediate transfer roller 15, an intermediate transfer belt cleaner 16, a transferer 17, a paper feed registration roller 18, a fixer 19, a paper discharger 20 and an optical scanner 21 as a developing unit.

The scanner 21, when an unillustrated start button on an operation display of the image forming apparatus is pushed or a printing job start signal from an unillustrated printer host thereof is activated, a timing-controlled light beam is irradiated onto the photoreceptor drums 10a to 10d.

The scanner 21 rotates two-staged polygon mirrors with an unillustrated polygon motor and scans the surface of each of the photoreceptor drums 10a to 10d with the light beam from a light source to form an electrostatic latent image thereon.

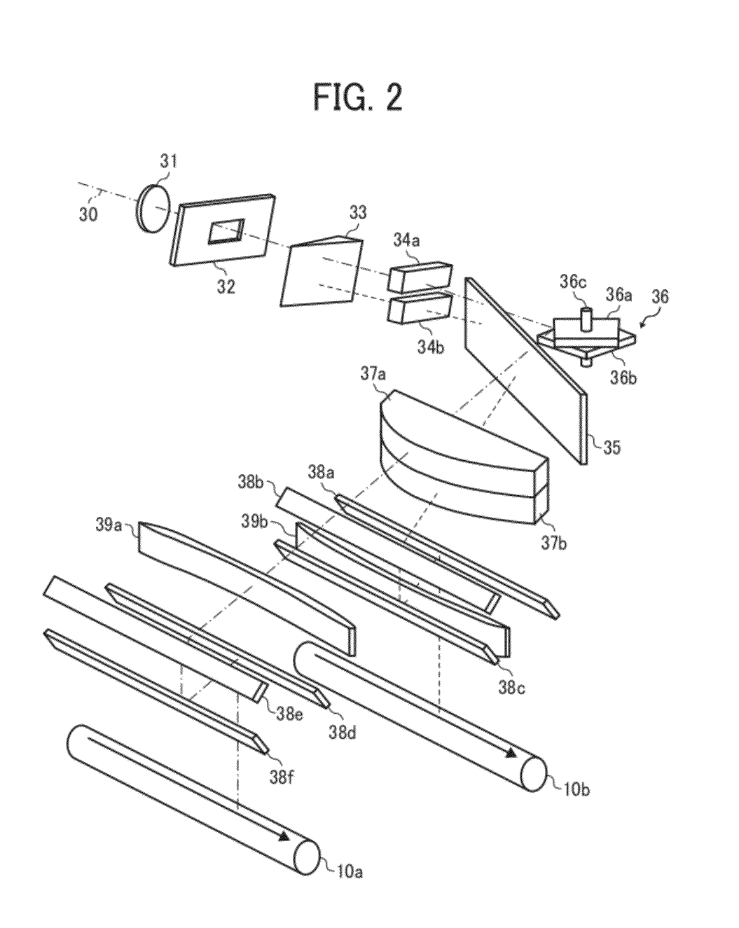

Namely, the photoreceptor drums 10a to 10d are equivalent to image bearers irradiated with each light beam deflected by a deflector 36 in FIG. 2 and an electrostatic latent image is formed on each of them.

The electrostatic latent image formed on each of the photoreceptor drums 10a to 10d is developed with a toner fed from the toner cartridges 12a to 12d, and a monochrome image is formed on each of the photoreceptor drums 10a to 10d.

When a black (K) toner image, a cyan (C) toner image, a yellow (Y) toner image and a magenta (M) toner image are formed on the photoreceptor drums 10a to 10d, respectively, a black toner adheres to the first photoreceptor drum 10a, and a black image is formed and transferred by the transfer roller 13a onto the intermediate transfer belt 14.

A cyan toner adheres to the next photoreceptor drum 10b, and a cyan image is formed and transferred by the transfer roller 13b onto the intermediate transfer belt 14. The cyan image is transferred onto the black image already formed on the intermediate transfer belt 14.

Further, a yellow toner adheres to the next photoreceptor drum 10c, and a yellow image is formed and transferred by the transfer roller 13c onto the intermediate transfer belt 14. The yellow image is transferred onto the black image and the cyan image already formed on the intermediate transfer belt 14.

Finally, a magenta toner adheres to the next photoreceptor drum 10d, and a magenta image is formed and transferred by the transfer roller 13d onto the intermediate transfer belt 14. The magenta image is transferred onto the black image, the cyan image and the yellow image already formed on the intermediate transfer belt 14.

The intermediate transfer belt 14 is rotated by the intermediate transfer roller 15 as a drive roller to transfer each of the color toner images in a direction of an arrow A to the transferer 17.

Thus, the color toner images K, C, Y and M are overlapped with each other on the intermediate transfer belt 14 to form a synthesized full-color image thereon.

In this embodiment, a black toner image, a cyan toner image, a yellow toner image and a magenta images are formed in this order, but the order of forming color toner images is not limited to this.

Meanwhile, in the image forming apparatus, an unillustrated paper feeder separates and feed a transfer paper S one by one when a job start signal is activated. When the transfer paper S is detected by an unillustrated paper registration sensor located near the paper feed registration roller 18, the transfer paper S stops at the paper feed registration roller 18.

Then, in synchronization with feeding of the synthesized full-color image on the intermediate transfer belt 14, the paper feed registration roller 18 rotates to feed the transfer paper S between the intermediate transfer belt 14 and the transferer 17.

The transferer 17 transfers the synthesized full-color image on the intermediate transfer belt 14 onto the transfer paper S, and the fixer 19 fixes the synthesized full-color image on the transfer paper S fed thereto upon application of heat and pressure.

The transfer paper S the synthesized full-color image is fixed on is discharged by a paper discharge roller of the paper discharger 20 and stacked on an unillustrated discharged paper tray.

Next, an inner configuration of the optical scanner 21 is explained.

FIG. 2 is a schematic view illustrating an inner configuration of an optical scanner in FIG. 1.

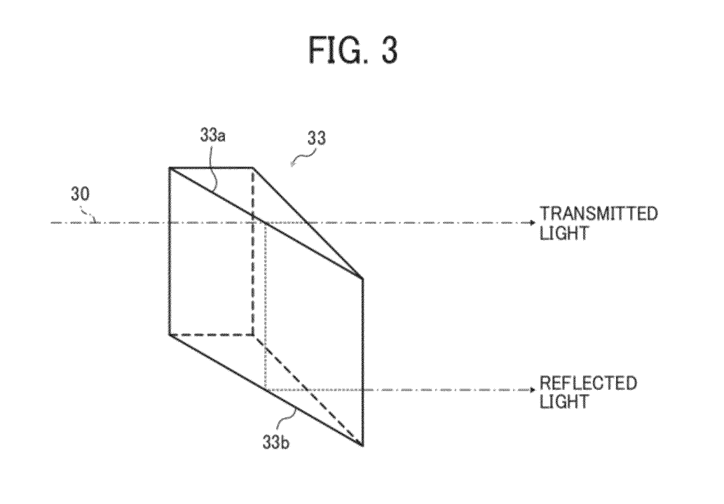

FIG. 3 is an apparent perspective view illustrating a half mirror prism in FIG. 2.

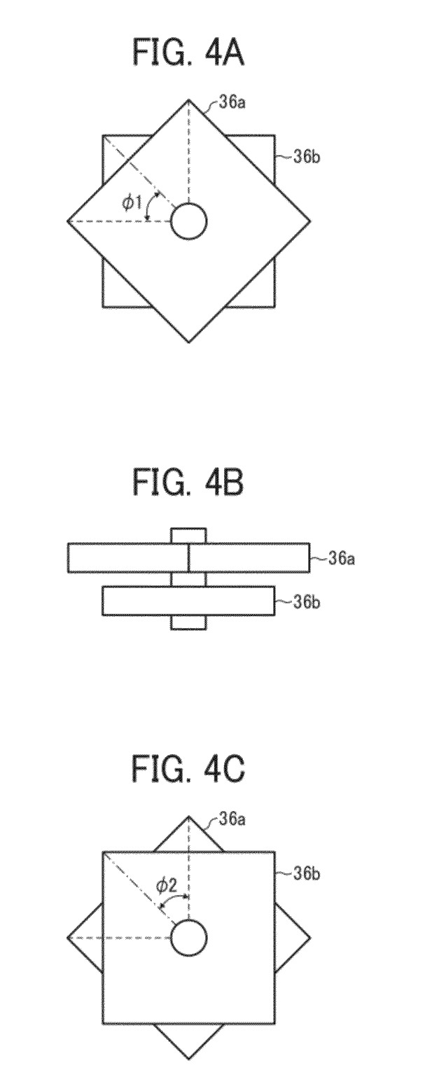

FIGS. 4A, 4B and 4C are apparent views illustrating an upper face, a side face and a bottom face of the polygon mirror in FIG. 2.

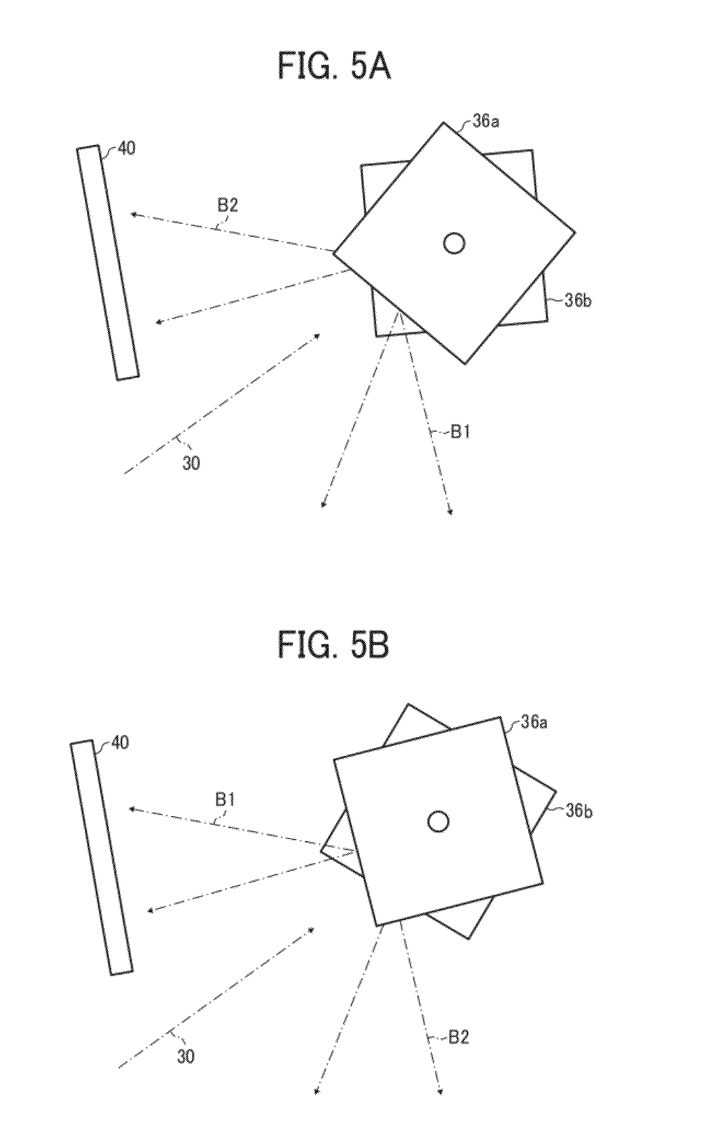

FIGS. 5A and 5B are schematic views for explaining movement of the polygon mirror in FIG. 2.

As FIG. 2 shows, the optical scanner 21 includes a coupling lens 31 converting light beam 30 which is a diverging light flux emitted from an unillustrated light source into a weak converging light flux, a parallel light flux or a weak diverging light flux; an aperture stop 32 stabilizing a beam diameter of the light beam 30 coming out from the coupling lens 31 on a surface to be scanned; and a half mirror prism 33 dividing the light beam from the light source to upper and lower stages.

When one light beam 30 is emitted from the light source, the half mirror prism 33 emits two light beams.

In this embodiment, the light source emits one light beam 30, but light beam 30 is not limited to one and may be two or more.

The half mirror prism 33 is explained, referring to FIG. 3,

FIG. 3 is a sub-scanning cross section of the half mirror prism 33.

The half mirror prism 33 includes a half mirror 33a dividing the light beam 30 having entered the half mirror prism 33 into transmitted light and reflected light at one-to-one ratio.

Further, the half mirror prism 33 includes a total reflection surface 33b capable of converting a direction of the light beam 30.

The light beam 30 coming out of the aperture stop 32 enters the half mirror prism 33 and is divided into upper-and-lower-stage transmitted light and reflected light by the half mirror 33a. The total reflection surface 33b further changes the direction of the reflected light, and the transmitted light and the reflected light are emitted to upper-and-lower-stage polygon mirrors 36a and 36b, respectively.

Namely, the half mirror prism 33 is a divider dividing the light beam from the light source into at least two light beams and having the divided light beams enter polygon minors at different stages.

In this embodiment, the half mirror prism 33 is used, but an optical device having the same capability using a single half mirror and a most commonly used mirror may be used.

The half mirror of the half mirror prism 33 does not divide light at the limited ratio of one-to-one, and may divide light at a proper ratio according to the other optical device conditions.

The optical scanner 21 explained, referring to FIG. 2 again.

The optical scanner 21 further includes cylindrical lenses 34a and 34b, soundproof glass 35, the polygon mirrors 36a and 36b, the deflector 36, scanning lenses 37a and 37b, mirrors 38a to 38g and scanning lenses 39a and 39b.

The light beam 30 coming out of the half mirror of the half mirror prism 33 is converted by the cylindrical lenses 34a and 34b located at the upper and lower stages, respectively to a latent image in a main scanning direction near a deflective reflection surface.

The deflector 36 has a rotational axis 36c the two-staged polygon mirrors 36a and 36b are circumferentially located on, and the lower-tired polygon mirror 36b is located with a shift of an angle of φ relative to the upper-tired polygon mirror 36a.

Namely, the deflector 36 includes a rotational axis and at least two-staged polygon mirrors circumferentially located on the rotational axis with a shift of an angle in a rotational direction, and reflects a light beam having entered each of the polygon mirrors while deflecting the light beam to scan the surface of each of the plural image bearers.

The polygon minors 36a and 36b may be integrally or separately formed.

When the polygon mirrors 36a and 36b have an equal shift angle φ in the rotational direction and M mirror surfaces in number, the shift angle φ is π/M.

When the number of the surfaces is 4, the shift angle is π/4, i.e., 45°.

When the shift angle is 45°, an interval since the upper-stage polygon mirror 36a starts scanning until the lower-stage polygon minor 36b starts scanning and an interval since the lower-stage polygon mirror 36b starts scanning until the upper-stage polygon mirror 36a starts scanning are the same. Therefore, which light beam is reflected at the upper stage or the lower stage cannot be distinguished.

The shift angle φ of the mirror surfaces is unequalized.

Specifically, the mirror surfaces are located to have a difference, of angle ±α such that the following relationships are satisfied:

φ1=π/M+α

φ2=π/M−α

wherein φ1 represents a shift angle of the mirror surface when the upper-stage polygon mirror 36a sees the lower-stage polygon mirror 36b as FIG. 4A shows; and φ2 represents a shift angle of the mirror surface when the lower-stage polygon mirror 36b sees the upper-stage polygon mirror 36a as FIG. 4C shows.

FIG. 4B is a side view of the FIG. 4A.

When the number of the mirror surfaces is 4 and the difference of angle α is 1°, φ1=46° and φ2=44°.

In this case, the interval since the upper-stage polygon mirror 36a starts scanning until the lower-stage polygon minor 36b starts scanning is longer than that since the lower-stage polygon mirror 36b starts scanning until the upper-stage polygon mirror 36a starts scanning. When the interval is longer, it is determined that the upper-stage polygon mirror 36a has scanned. When shorter, it is determined that the lower-stage polygon mirror 36b has scanned. Therefore, the difference of angle α can detect which stage scans.

A component tolerance when the polygon mirrors 36a and 36b are asset 1.e is a large parameter for a range of the difference of angle α.

The tolerance is a legally permitted difference between a specified value and an actual value in mechanical processing.

When the component tolerance is ±0.25°, φ1=φ2 even when α is 0.25, and the upper and lower stages of the polygon mirrors 36a and 36b cannot be detected.

When α is less than 0.25, a magnitude relation between φ1 and φ2 reverses, and the upper and lower stages of the polygon mirrors 36a and 36b can be detected, but the result is reversed.

Therefore, α needs to be more than 0.25.

When the component tolerance is ±0.5°, φ1=φ2 even when α is 0.5, and the upper and lower stages of the polygon mirrors 36a and 36b cannot be detected.

Therefore, α needs to be more than 0.5.

α can be 0.5005, which is larger than 0.5 just by 0.0005. However, there is a difference not less than a few hundred in counting intervals of detection signals with a high-speed clock, and the upper and lower stages can fully be detected.

Therefore, when the component tolerance is ±0.25°, the minimum value of the difference of angle α is greater than an absolute value 0.25′ of the tolerance, e.g., 0.2505°.

When the component tolerance is ±0.5°, the minimum value of α is greater than an absolute value 0.5° of the tolerance, e.g., 0.5005°.

Meanwhile, the maximum value of the difference of angle α is preferably from 0.9 to 1.35° which are 2 to 3% of 45° because a control clock for scanning a main scanning width needs to have largely higher speed since a deflection angle corresponding to an effective writing width capable of scanning a photoreceptor drum with a mirror surface at a stage where intervals of detection signals are short becomes small when α is large.

The optical scanner 21 can detect which stage scans with the deflector 36 having the difference of angle α.

When the optical scanner 21 is equipped with the deflector 36 having the difference of angle α of 0, the upper and lower stages of the polygon mirrors 36a and 36b cannot be detected, but the intervals are detected to be equal and regular and no angle difference is detected.

Therefore, even when the polygon mirrors 36a and 36b are produced so as not to have a difference of angle, they are detected to have that when produced if the detection signals have different intervals.

Actual scanning of the optical scanner 21 is explained. As FIG. 5A shows, when a light beam B1 of the upper stage from a common light source scans a photoreceptor drum (surface to be scanned), alight shutter 40 shuts a light beam B2 of the lower stage so as not to reach the surface to be scanned.

In addition, as FIG. 5B shows, when the light beam B2 of the lower stage from the common light source scans a photoreceptor drum (surface to be scanned), the light shutter 40 shuts the light beam. B1 of the upper stage so as not to reach the surface to be scanned.

Next, a main configuration of a controller in the optical scanner 21 and scan control performed thereby are explained in detail.

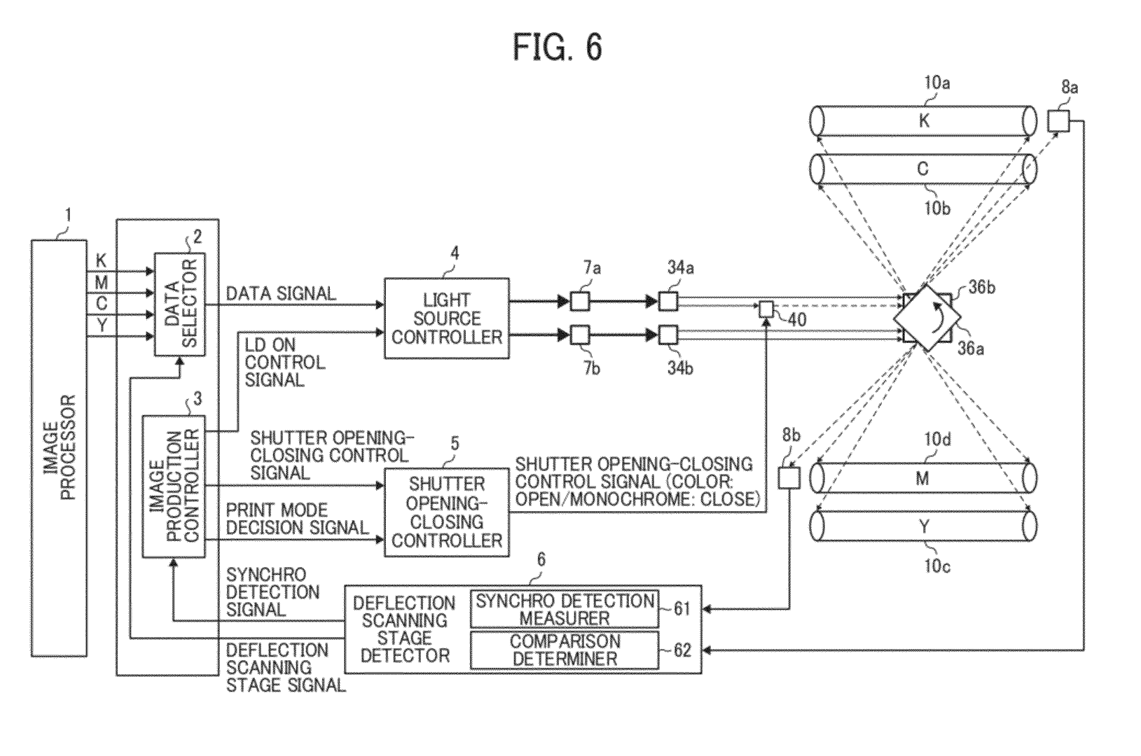

FIG. 6 is a diagram showing a main configuration of the controller of the optical scanner 21 in FIG. 1.

The controller is formed of microcomputers including CPU, ROM and RAM, and includes an image processor 1, a data selector 2, an image production controller 3, a light source controller 4, a shutter opening-closing controller 5 and a deflection scanning stage detector 6.

The deflection scanning stage detector 6 further includes a synchro detection measurer 61 and a comparison determiner 62.

The light source controller 4 transmits a modulated signal to each of light sources 7a and 7b to control each of light beams emitted therefrom to the upper-stage polygon mirror 36a and the lower-stage polygon mirror 36b.

A light beam emitted from each of the light sources 7a and 7b transmits through each of the cylindrical lenses 34a and 34b and enters each of the upper-stage polygon mirror 36a and the lower-stage polygon mirror 36b.

Each of the polygon mirrors 36a and 36b rotates to emit the light beam in a main scanning direction to scan each of the photoreceptor drums 10a to 10d through the scanning lenses 37a and 37b and mirrors 38a to 38f in FIG. 2 (omitted in FIG. 6).

A rotational position of each of the polygon mirrors 36a and 36b is detected by each of light receiving elements 8a and 8b as a synchro detector located at each of scanning end positions as a synchro detection signal indicating a main scan starting position.

The synchro detection signal is so called as each of the light receiving elements 8a and 8b detects a light beam at the same time.

Namely, the light receiving elements 8a and 8b serve as light receiver detecting light beams scanned on the photoreceptor drums 10a to 10d.

The synchro detection signal detected by each of the light receiving elements 8a and 8b enters the deflection scanning stage detector 6, in which the synchro detection measurer 61 measures an interval of the synchro detection signals.

A result of the measurement by the synchro detection measurer 61 is compared by the comparison determiner 62 with a predetermined value.

Namely, the synchro detection measurer 61 serves as a detector detecting scan timing of the polygon mirror of each of the stages, based on the intervals of the light beams detected by the light receiver.

The predetermined value is a limit value for determining the upper or lower stages of the polygon mirrors 36a and 36b, a fixed value or a value just before measured by the synchro detection measurer 61.

When the predetermined value is a fixed value, the fixed value can be an average (Ta+Tb)/2 of an interval (Ta) from receipt of a synchro detection signal produced by the light receiving element 8a having detected a light beam reflected by the upper-stage polygon mirror 36a until receipt of a synchro detection signal produced by the light receiving element 8h having detected a light beam reflected by the lower-stage polygon mirror 36b, and an interval (Tb) from receipt of a synchro detection signal produced by the light receiving element 8b having detected a light beam reflected by the lower-stage polygon mirror 36b until receipt of a synchro detection signal produced by the light receiving element 8a having detected a light beam reflected by the upper-stage polygon mirror 36a.

When the predetermined value is a value just before measured by the synchro detection measurer 61, in an optical device in which Tb is longer than Ta, a result measured by the synchro detection measurer 61 alternately repeats a longer one and a shorter one, the value just before measured is compared with the present value, and it is determined that the lower stage was scanned when the present value is larger and the upper stage when the present value is smaller.

Based on the decision result, the comparison determiner 62 transmits a deflection scanning stage signal determining mirror surfaces on the upper stage or the lower stage to be scanned to the data selector 2.

Based on the deflection scanning stage signal from the comparison determiner 62, the data selector 2 synthesizes image data from the image processor 1.

The image processor 1 enters four color image data, i.e., black (K) color image data, cyan (C) color image data: yellow (Y) color image data and a magenta (M) color image data into the data selector 2.

Locations of the optical scanner 21 and the photoreceptor drums 10a to 10d decide a color of a toner image each of the light sources 7a and 7b forms.

A case where the light source 7a forms a black color image and a cyan color image and the light source 7b forms a yellow color image and a magenta color image is explained. Based on the deflection scanning stage signal from the comparison determiner 62, the data selector 2 transmits a data signal synthesizing a black image data and a cyan image data as an image data for the one light source 7a and a data signal synthesizing a yellow image data and a magenta image data as an image data for the one light source 7b to the light source controller 4.

The light source controller 4 transmits a modulated signal to each of the light sources 7a and 7b, and each of the light sources 7a and 7b emits a light beam based on the signal to form a desired electrostatic latent image on each of the photoreceptor drums 10a to 10d.

The optical scanner 21 includes the light shutter 40 mentioned later on a light path of a light beam for forming a cyan image, and the shutter opening-closing controller 5 controls operation of closing and opening the light shutter 40.

The light shutter 40 and the shutter opening-closing controller 5 serve as a shutter shutting a light beam irradiated to unused image bearers during a period when the light source light up before timing of scanning with the polygon mirror of each stage is detected, based on detection intervals of light beams.

In this embodiment, one light source forms two color images, and the two light source 7a and 7b form four K, C, M and Y color images as FIG. 6 shows. However, the number of the light sources is not limited to two, and two (four) light sources may be used to form two (four) color images.

In addition, not only a laser diode light source which is a single light source element having one luminous point, but also a laser diode array having plural luminous points or a surface-emitting laser diode having two-dimensional luminous points can be used as the light sources 7a and 7b.

In the image forming apparatus of the present invention, particularly the surface-emitting laser diode is effectively used to reduce the number of components.

An operation of printing color images has been explained, and an operation of printing monochrome images is explained.

First, a conventional operation of the optical scanner when printing monochrome images while opening the light shutter 40 is explained.

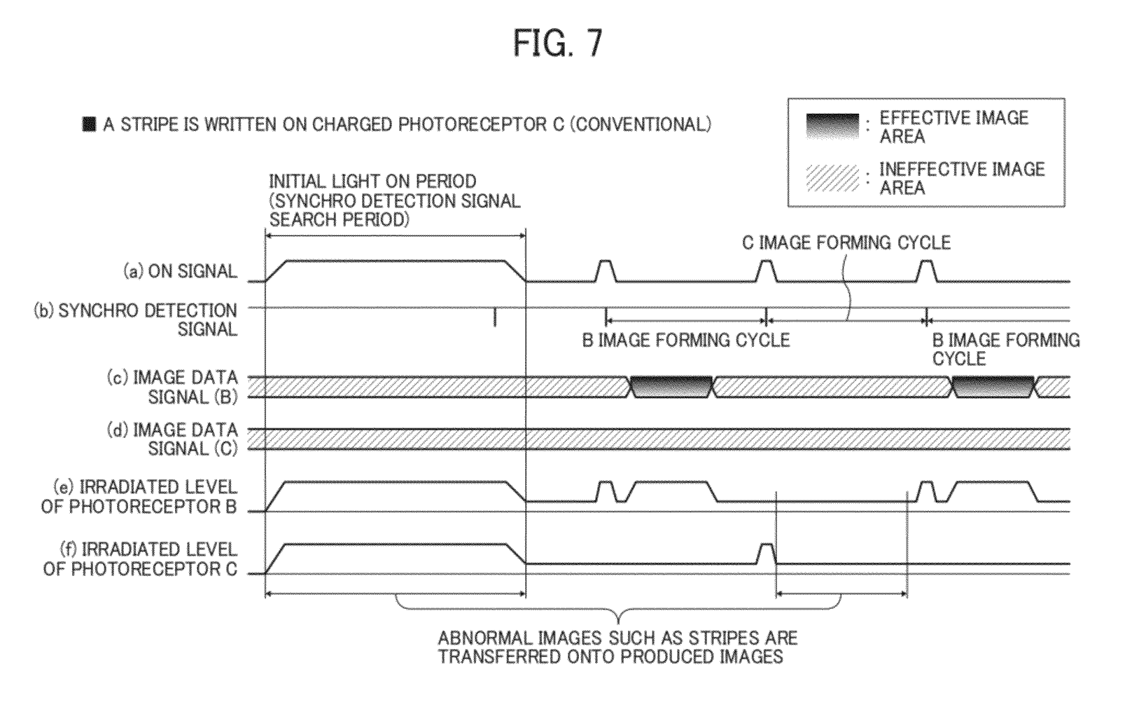

FIG. 7 is a diagram showing a signal variation relating to a conventional operation of the optical scanner 21 when producing images while opening the light shutter 40 in FIG. 6.

Only a black (K) color image is formed in monochrome printing, and the other three cyan (C), yellow (Y) and magenta (M) color images are not formed.

The light source 7h is put off so as not to irradiate the photoreceptor drums 10c and 10d for yellow (Y) and magenta (M) at any time.

However, in the optical scanner 21, the same light source 7a emits a light beam for black (K) to the upper-stage polygon mirror 36a and a light beam for cyan (C) to the lower-stage polygon mirror 36b, and therefore a light beam is emitted not only to the photoreceptor drum 10a for black (K), but also to the photoreceptor drum 10b for cyan (C).

While the light shutter is opened in monochrome printing, the black and cyan photoreceptor drums 10a and 10b are continuously irradiated for long periods depending on timing of starting emitting during an initial light up period (FIG. 7(a)) until a synchro detection signal (FIG. 7(b)) before forming images is produced as FIG. 7 shows.

The beam strength in the period is almost a maximum level because of detecting synchronization.

Since the cyan photoreceptor drum 10b does not rotate and remains still, the light beam is continuously emitted to the same position, and which is too charged to discharge in the following discharge process.

Therefore, unintentional electrostatic latent image such as striped are formed on the cyan photoreceptor drum 10b in a state of FIG. 7 (f).

When a monochrome printing is required in the image forming apparatus, a black toner adheres to the photoreceptor drum 10a to form a black image, and which is transferred by the transfer roller 13a onto the intermediate transfer belt 14 in FIG. 1.

A cyan electrostatic latent image is formed on the photoreceptor drum 10b, and a cyan toner adheres thereto to form a cyan image, which is transferred by the transfer roller 13b onto the intermediate transfer belt 14.

A cyan image is transferred onto a black image on the intermediate transfer belt 14 as it is in full-color printing.

Since the light source 7b does not emit light beams to the yellow and magenta photoreceptor drums 10c and 10d, electrostatic latent images are not formed thereon and yellow and magenta images are not formed on the intermediate transfer belt 14.

Toner images each having a color different from each other are overlapped on the intermediate transfer belt 14 to form a synthesized image as they are in full-color printing.

Only a black image should be transferred as a desired image, but in a conventional configuration a cyan image such as stripes are formed, resulting in production of abnormal images as unintentional images.

While images are formed even besides the initial light up period, the light sources 7a and 7b light up at an image forming cycle interval to obtain a synchro detection signal.

After a black image is formed, it is necessary to obtain a synchro detection signal correspondent to the lower-stage polygon mirror 36b and the light source 7a is lighted up through the image production controller 3.

Namely, a high-intensity light beam is continuously irradiated to the same position of the cyan photoreceptor drum 10b as it is in the initial light up period. As a result, an unintentional electrostatic latent image is formed, and an abnormal image which is a black image overlapped with a cyan image is produced.

In consideration of the above-mentioned problem, the image forming apparatus of the present invention includes the optical scanner 21 including the light shutter 40 to solve this problem.

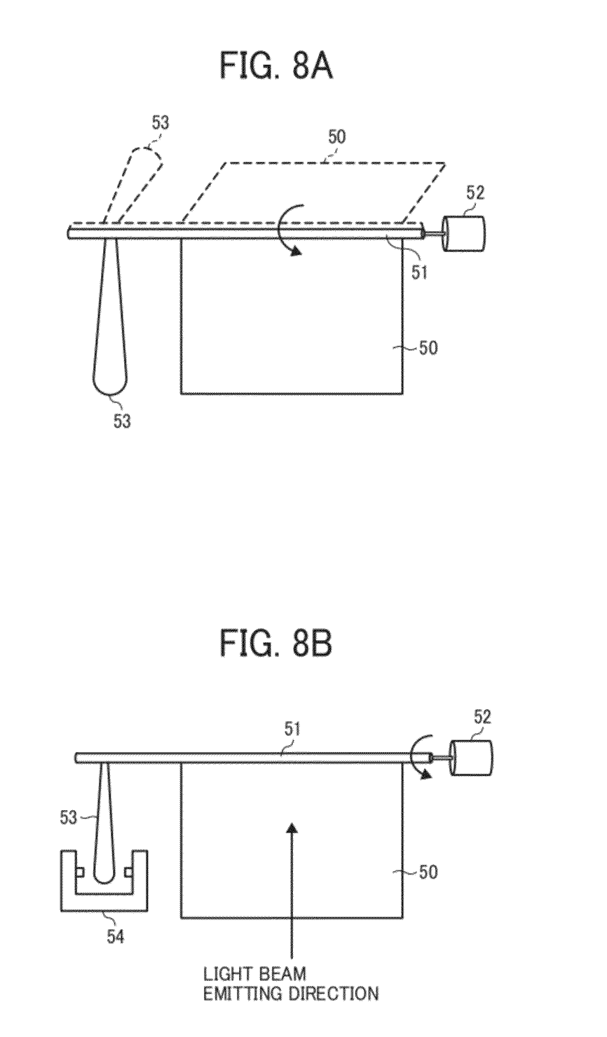

FIGS. 8A and 8B are schematic views illustrating a mechanical shutter used as the light shutter 40.

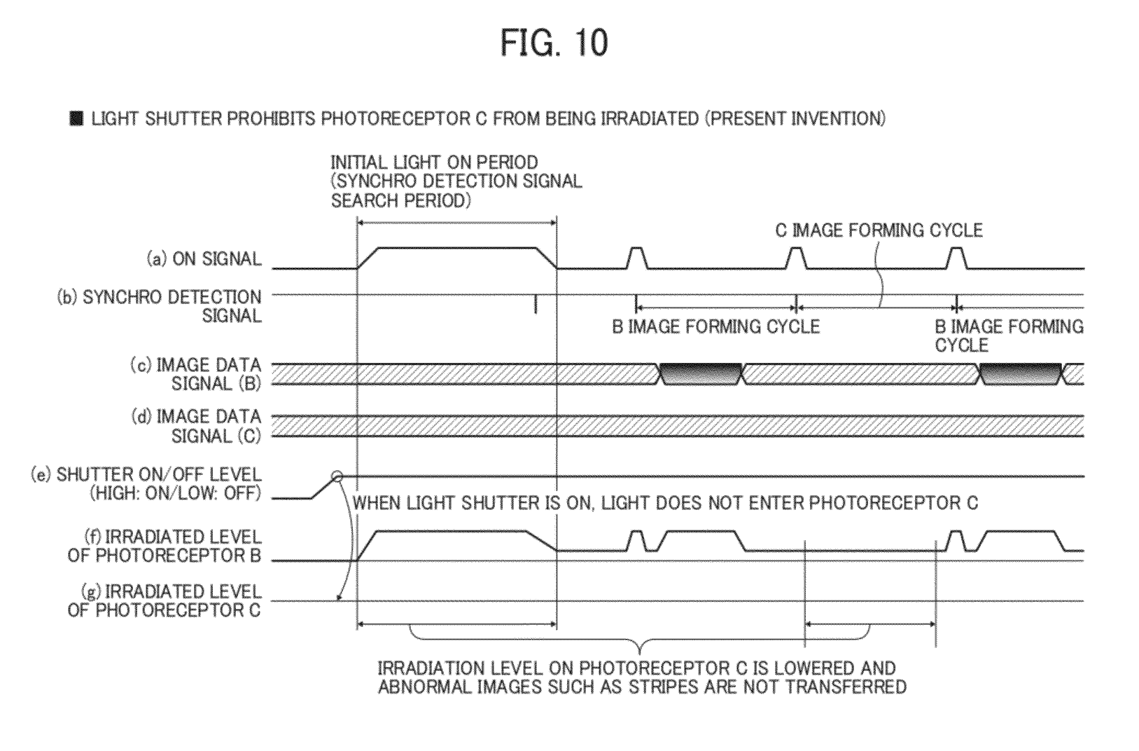

FIG. 10 is a diagram showing a signal variation relating to an operation of the optical scanner 21 when monochrome images are produced using the light shutter 40 in FIG. 6.

The light shutter 40 is located between the half mirror prism 33 and the lower stage polygon mirror 36b for the unused photoreceptor drum 10b.

A light beam needs emitting to the lower-stage polygon mirror 36b to form a cyan image when a full-color image is printed.

In this case, the image production controller 3 transmits a print mode decision signal deciding whether a monochrome or a full-color image to be printed to the shutter opening-closing controller 5.

As levels of the print mode decision signal, monochrome printing is Low and full-color printing is High, and as FIG. 10 (e) shows, a request for opening the light shutter 40 (OFF) is Low and a request for closing the light shutter 40 (ON) is High as levels of the shutter opening-closing control signal.

In full-color printing, right after the shutter opening-closing controller 5 detects a High level print mode decision signal, it transmits a Low level shutter opening-closing control signal to the light shutter 40 to be OFF.

When the light shutter 40 detects the Low level signal, it rotates a drive motor 52 after a fixed period to rotate a light shut filter 50 (equivalent to a shutter) formed on a rotational axis 51 and open the shutter so as to open a light path of a light beam such that the light beam is emitted to the lower-stage polygon mirror 36b afterwards.

In full-color printing, right after the shutter opening-closing controller 5 detects the print mode decision signal, it gives an instruction of opening the light shutter 40 to prevent a light beam from the light source 7a from being mistakenly shut.

Accordingly, an electrostatic latent image correspondent to the upper-stage and lower-stage polygon mirrors 36a and 36b is formed to produce an optimal image.

Next, a monochrome printing operation using a mechanical shutter as the light shutter 40 is explained.

As FIG. 8A shows, the light shutter 40 includes the drive motor 52 including the rotational axis 51, and the light shut filter 50 thereon. The drive motor 53 rotates the rotational axis 51 to close or open a light path of a light beam with the light shut filter 50.

In monochrome printing, the image production controller 3 transmits a Low level print mode decision signal for monochrome printing to the shutter opening-closing controller 5.

The shutter opening-closing controller 5 transmits a High level shutter opening-closing control signal to the light shutter 40, and which doses the shutter to shut alight beam from the light source 7a.

When the shutter opening-closing control signal becomes High after the image production controller 3 transmits an LD light up control signal, the cyan photoreceptor drum 10b is possibly irradiated.

When the image production controller 3 transmits an LD light up control signal after the shutter opening-closing controller 5 transmits a High level shutter opening-closing control signal, the light source 7a emits a light beam after the shutter opening-closing controller 5 closes the light shutter 40 and the light beam is shut and does not reach the polygon mirror 36b, which prevents the cyan photoreceptor drum 10b from being irradiated.

Therefore, as FIG. 10 (g) shows, the photoreceptor drum 10b is not irradiated, and abnormal image such as stripes are not transferred thereby when forming images.

However, the light shutter 40 cannot instantly rotate the light shut filter 50 to shut a light beam and needs a shutter reaction time.

Namely, there is a waiting time for the shutter reaction time since a shutter opening-closing control signal is detected until the light shutter 40 is closed.

Should the image production controller 3 transmit an LD light up control signal right after a High level shutter opening-closing control signal is transmitted, the cyan photoreceptor drum 10b is irradiated during a reaction time until the shutter is closed.

The image production controller 3 waits for the shutter reaction time and transmits an LD light up control signal after a High level shutter opening-closing control signal is transmitted, which prevents the cyan photoreceptor drum 10b from being irradiated.

The light shutter 40 opens and closes, depending on whether the light shut filter 50 is positioned in a direction parallel to a direction of a light beam emitted from the half mirror prism 33 not to shut the light beam or a direction perpendicular thereto to shut the light beam.

However, when paper jams or breakdowns in the image forming apparatus abruptly put off an electric source of the drive motor 52 driving the light shut filter 50, it possibly does not stop at the above-mentioned position.

Since a starting position is different from the standard position, whet the light shut filter 50 is opened and closed as when it normally operates, it passes a position where to stop and hits against other members or stops too short of the position to shut a light beam.

In order that the light shut filter 50 stops at a right position, as FIG. 8B shows, a sensor 54 detecting a home position perpendicular to a direction o a light beam emitted from the half mirror prism 33 is located.

The light shutter 40 includes a light shut board 53 for sensor detected by the sensor 54 in a direction perpendicular to the rotational axis 51.

The sensor 54 transmits a High level signal representing the light shut board 53 for sensor is in the sensor 54 when traveling in a detective range thereof and a Low level signal representing the light shut board 53 is out of the sensor 54 when traveling out of the detective range thereof.

When the light shutter 40 closes after opening, the light shut board 53 for sensor travels in the detective range of the sensor 54 from an outside thereof.

When the sensor detects the light shut board 53 for sensor when traveling in the detective range thereof, it transmits a High level sensor detection signal to the image production controller 3.

The image production controller 3 uses the sensor detection signal from the sensor 54 to monitor whether the light shutter 40 closes or opens (completely opens or closes a light path of a light beam) in real time.

When paper jams, etc. abruptly put off an electric source of the drive motor 52, the light shut filter 50 of the light shutter 40 possibly stops at a position out of a desired position.

When an electric source of the drive motor 52 is turned on, the light shut filter 50 of the light shutter 40 is moved to a home position first.

However, the light shut filter 50 of the light shutter 40 at the home position is located perpendicular to a direction of a light beam emitted from the half mirror prism 33 to shut the light beam.

When the image production controller 3 controls not to shut light, an unintentional image without a cyan image is possibly produced in full-color printing.

Regarding a sensor detection signal produced when the light shut filter 50 of the light shutter 40 is moved to the home position after the electric source of the drive motor 52 is turned on as a trigger, the image production controller 3 transmits a shutter opening-closing control signal to the shutter opening-closing controller 5, based on a print mode decision signal and a synchro detection signal from the deflection scanning stage detector 6 produced inside to move the light shut filter 50 of the light shutter 40 to a position where it should be at.

Next, a liquid crystal shutter as the light shutter is explained.

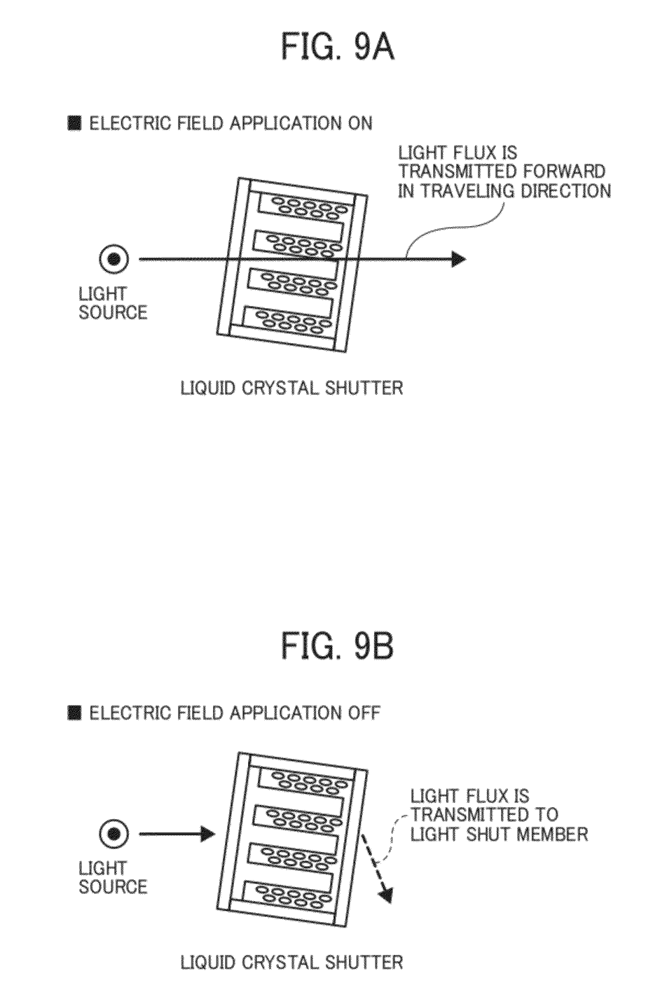

FIGS. 9A and 9B are schematic views illustrating emitting direction of the light beam at ON/OFF of electric field application when a liquid crystal shutter is used as the light shutter 40.

The liquid crystal shutter for shutting light is capable of changing a diffraction coefficient of light when a voltage level applied to the shutter is changed.

When the liquid crystal shutter for shutting light lowers the diffraction coefficient in proportion to a voltage applied thereto, as FIG. 9A shows, light is transmitted in a direction out of a direction of its travelling direction when a voltage is not applied thereto. Light is transmitted in a direction of its travelling direction when a a specific voltage is applied to the liquid crystal shutter.

As FIG. 9B shows, the shutter opening-closing control signal controls a voltage applied to the liquid crystal shutter for shutting light to shut light as the mechanical shutter does.

Namely, when the shutter opening-closing control signal is Low level, a specific voltage or higher is applied to the liquid crystal shutter to irradiate a light beam to the polygon mirror 36b. When the shutter opening-dosing control signal is High level, a voltage is not applied to the liquid crystal shutter to prevent a light beam from irradiating the polygon mirror 36b. Even when the liquid crystal shutter for shutting light is used, the image production controller 3 and the shutter opening-closing controller 5 are controlled as they are when the mechanical shutter is used in monochrome printing.

Next, an operation of making the light shutter ON has been explained, and an operation of making it OFF is explained.

The light shutter 40 consumes electric power only when keeping ON, and a time when it is ON is preferably as short as possible in terms of saving energy.

The cyan photoreceptor drum 10b is irradiated during only a period when an LD is lighted up and not during the other periods.

Namely, the light shutter 40 can be OFF during a period when an LD is not lighted up.

The light shutter 40 may be OFF during a period when the LD is not lighted up even in full-color printing.

Regardless of whether monochrome or full-color printing, the light shutter 40 is preferably OFF when an LD is lighted out.

When the light shutter 40 is OFF before the LD is lighted out, the cyan photoreceptor drum 10b is irradiated until the LD is lighted out.

Therefore, after the image production controller 3 instructs the light source controller 4 to light out the LD, it transmits a Low level shutter opening-closing control signal to the light shutter 40 after confirming the light source controller 4 has lighted out the LD.

Thus, the light shutter 40 is located between the half mirror prism 33 and the polygon mirror 36b for the photoreceptor drum 10b forming cyan color images which is not used in monochrome printing and shuts light during a period when the LD is lighted up according to print mode (monochrome/color) before synchro is detected at a proper timing to produce optimum images.

Further, the sensor 54 detects a position of the light shut filter 50 (whether the shutter is opened or closed) of the light shutter 40 to prevent a photoreceptor drum which is not used from being erroneously irradiated and producing abnormal images.

In the present invention, the light shutter is located between the cylindrical lens and the polygon mirror on a light path of the photoreceptor which is not used, and a light beam to the polygon mirror therefor can be shut during a period when a light source is lighted up before synchro is detected in monochrome printing. Further, it prevents the photoreceptor from being irradiated with an unnecessary light beam for a long time, deteriorating in its surface and producing abnormal images.

In the image forming apparatus of the present invention, all light beams separately located at the upper and lower stages are used in full-color printing and the light shutter is constantly opened to pass necessary light beams to properly produce images.

When the light shutter is closed during a period when the light source is lighted up before synchro is detected, an unintentional electrostatic latent image is possibly formed on the photoreceptor which is not used.

In the image forming apparatus of the present invention, the image production controller does not light up the light source before synchro is detected until instructing the light shutter to close to precisely shut an unnecessary light beam to the photoreceptor which is not used and prevent an unintentional electrostatic latent image from being formed thereon.

The light shutter needs a specific (a shutter reaction time) time from receiving an instruction from the image production controller to reacting. When the light source is lighted up right after the light shutter is instructed to close, the light beam is not possibly shut and irradiated to the photoreceptor which is not used.

In the image forming apparatus of the present invention, the light source does not start lighting up until the light shutter reacts after instructed to close, and alight beam does not pass before the light shutter is closed to prevent an unintentional electrostatic latent image from being formed on a photoreceptor which is not used.

Even when the shutter is instructed to open or close, whether the shutter is actually activated as instructed cannot be determined.

In the image forming apparatus of the present invention, a transmission sensor detecting whether the light shutter opens or closes is used. When the transmission sensor detects a positional gap of the light shutter, lighting up the light source does not start until the light shutter is detected to correctly close to precisely shut light.

Further, when image formation is finished, i.e., a print job is completed, the light source lights out, and the light shutter does not need to be close and can be open.

As mentioned above, the light shutter can constantly be opened in full-color printing, and the light shutter can be opened regardless of the print mode. However, when the light shutter is opened before the light source is lighted out, a light beam is not possibly shut and irradiated to the photoreceptor which is not used. The light shutter is preferably instructed to open after the image production controller lights out the light source. This prevents the light shutter from needlessly shutting light and enables the light shutter to shut light at a proper timing.

Additional modifications and variations of the present invention are possible in light of the above teachings. It is therefore to be understood that within the scope of the appended claims the invention may be practiced other than as specifically described herein.

What is claimed is:

1. An image forming apparatus, comprising:
a deflector, comprising a rotational axis and at least two-staged polygon mirrors circumferentially located on the rotational axis at shifted angles in a rotational direction thereof, configured to reflect a light beam entering each of the polygon mirrors while deflecting the light beam to scan plural image bearers;
a divider configured to divide the light beam from alight source into at least two light beams to enter the polygon mirrors at different stages, respectively;
a light receiver configured to detect the light beam reflected from the deflector;
a detector configured to detect timings of the two-staged polygon mirrors to scan, based on a light beam detection interval detected by the light receiver; and
a light shutter configured to shut a light beam entering an unused image bearer among the plural image bearers during a period when the light source lights up before the detector detects the timings.

2. The image forming apparatus of claim 1, wherein the light source lights up after the light shutter shuts the light beam in monochrome printing.

3. The image forming apparatus of claim 1, wherein the light source does not light up until shutting light by the light shutter is effective in monochrome printing.

4. The image forming apparatus of claim 1, wherein the light shutter comprises a shutter configured to close a light path of the not beam entering the unused image bearer, and further comprising a second detector configured to detect opening and closing of the shutter, wherein the light source lights up after the second detector detects closing of the shutter in monochrome printing.

5. The image forming apparatus of claim 4, wherein the shutter is kept opening or closing when image formation is finished.

6. The image forming apparatus of claim 4, wherein the shutter is kept opening or closing after the light source lights out.

7. An image forming apparatus, comprising:
a deflecting means, comprising a rotational axis and at least two-staged polygon mirrors circumferentially located on the rotational axis at shifted angles in a rotational direction thereof, configured to reflect a light beam entering each of the polygon mirrors while deflecting the light beam to scan plural image bearers;
a dividing means configured to divide the light beam from a light source into at least two light beams to enter the polygon mirrors at different stages, respectively;
a light receiving means configured to detect the light beam reflected from the deflector;
a detecting means configured to detect timings of the two-staged polygon minors to scan, based on a light beam detection interval detected by the light receiver; and
a light shutting means configured to shut a light beam entering an unused image bearer among the plural image bearers during a period when the light source lights up before the detector detects the timings.

8. The image forming apparatus of claim 1, wherein the light source lights up after the light shutting means shuts the light beam in monochrome printing.

9. The image forming apparatus of claim 1, wherein the light source does not light up until shutting light by the light shutting means is effective in monochrome printing.

10. The image forming apparatus of claim 1, wherein the light shutting means comprises a shutter configured to close a light path of the light beam entering the unused image bearer, and further comprising a second detecting means configured to detect opening and closing of the shutter, wherein the light source lights up after the second detecting means detects closing of the shutter in monochrome printing.

11. The image forming apparatus of claim 4, wherein the shutter is kept opening or closing when image formation is finished.

12. The image forming apparatus of claim 4, wherein the shutter is kept opening or closing after the light source lights out.
